(19) United States
(12) Patent Application Publication
(10) Pub. No.: US 2025/0116288 A1
(43) Pub. Date: Apr. 10, 2025

(54) FASTENER ASSEMBLY AND METHOD OF ASSEMBLY OF THE FASTENER ASSEMBLY

(71) Applicant: Aptiv Technologies AG, Schaffhausen (CH)

(72) Inventors: Pawel KWIATKOWSKI, Radom (PL); Rafal JANCZYK, Krakow (PL); Piotr KULINOWSKI, Wola Rzedzinska (PL)

(21) Appl. No.: 18/910,264

(22) Filed: Oct. 9, 2024

(30) Foreign Application Priority Data
Oct. 10, 2023 (EP) 23202863.9

(51) Int. Cl. F16B 19/02

(52) U.S. Cl. CPC F16B 19/02

(57) ABSTRACT

The disclosure presents a fastener assembly comprising a plastic element with a fixing portion in the form of a plate having a top face and a bottom face, an inlet open at the edge, and locking means. The plastic element includes longitudinal and bottom border segments defining the inlet. Additionally, a metal insert with two legs and a junction between them, forming a U-shape, is provided. Each leg of the metal insert includes hooking means that cooperate with the locking means of the plastic element. This fastener assembly allows for secure and efficient fastening of components in various applications.

### CROSS-REFERENCE TO RELATED APPLICATION

This application claims the benefit of and priority to European Patent Application No. 23202863.9 filed on Oct. 10, 2023, the contents of which are incorporated by reference herein.

### TECHNICAL FIELD

The disclosure relates to a fastener assembly and method of assembly for use in fastening together parts of motor vehicles.

### BACKGROUND

In general, prior art fasteners use bolt-type devices with threaded rods, nuts and washers. Alternatively, devices using clips or circlips fastened/attached to rods or studs can be used. However, in general, if a threaded or unthreaded rod is used, the part to be mounted on the rod must be brought parallel to the longitudinal direction of the rod, so that an opening provided on the part to be mounted on the rod (parallel to the longitudinal direction of the rod) is fitted onto that rod.

Year after year, changes are introduced into automotive production to make vehicles more robust and reliable, while at the same time seeking to make them lighter, easier to assemble, with more functions, more economical to manufacture and use, and so on. Ever-increasing demands for manufacturing quality and improved production and assembly processes contribute to the search for new solutions. For example, the new solutions developed must meet particular requirements in terms of anti-vibration, assembly process or temperature resistance, particularly in the case of high-voltage electrical circuit components for electric and hybrid vehicles, for which the new harness architecture requires, for example, stable and durable wiring channels in tight spaces. Ease of manufacture is also an important factor, as using parts that are easy to handle helps to reduce errors.

A fastener assembly and an assembly method that at least partially meet the requirements of modern assembly processes are disclosed below.

### SUMMARY

The present disclosure relates to a fastener assembly including a plastic element fixed to the metallic element at the fastening region. The plastic element has a fixing portion in the form of a plate having a top face and a bottom face. The plate extends essentially in a plane and being provided with an edge and an inlet open at the edge (i.e., having a cut-out shape). The inlet is bordered by two longitudinal border segments extending parallel to the plane of the plate in an insertion direction, and a bottom border segment also extending parallel to the plane of the plate between the two longitudinal border segments. The plastic element also includes locking means. The fastener element also includes a metal insert having two legs and a junction between the two legs. The metal insert is essentially U-shaped. The insert is inserted into the inlet. Each one of the legs includes hooking means which cooperate with the locking means.

This fastener assembly is configured to be fastened on a metallic element having a fastening region, a rod (e.g., the rod of a stud or a stud) being secured to the metallic element and extending substantially perpendicularly to the fastening region. The metal insert is then positioned with the rod placed between the two legs.

Due to the cut-out shape of the inlet, the process of assembling the metallic element with the plastic element is much faster and improves the quality of production and its efficiency. This translates directly into lower costs and eliminates the need for special tools.

The metal insert acts as a spacer. It ensures that a washer or a nut, for example, does not crush or deform the plastic element when it is fitted and tightened on the rod. Tightening only takes place between metal parts (the metal element, the metal insert and the nut and/or washer, for example). In this way, the plastic element is held firmly on the metal element. This hold is reliable over time, even if the temperature becomes relatively high and/or if the plastic element is subjected to vibrations.

In an example embodiment, the fastener assembly includes, on both the top face and the bottom face, a raised rim around the inlet and the locking means includes at least one locking surface formed on the top face, in the raised rim, perpendicular to the insertion direction; then the hooking means cooperates with/engages the at least one locking surface. Therefore, for example, the metal insert remains fastened onto the plastic element, even if the plastic element is not mounted on the rod yet.

According to an embodiment, on at least one of top face and the bottom face, the raised rim includes, in the vicinity of the edge, at least one notch for accommodating hooking means. In other words, the top and bottom faces are not necessarily symmetrical in relation to the median plane of the plate of the plastic element.

In an example of embodiment, the plastic element includes on both the top face and the bottom face, a raised rim around the inlet, the locking means including at least one locking surface formed on both the top face and the bottom face, in the raised rim, the at least one locking surface being perpendicular to the insertion direction, and the hooking means cooperating with the at least one locking surface on both the top face and the bottom face. In other words, in this example of embodiment, the top and bottom faces are symmetrical in relation to the median plane of the plate of the plastic element.

According to an embodiment, the raised rim includes, in the vicinity of the edge, slanted surfaces configured to case the insertion, in the insertion direction, of the insert in the inlet.

According to an embodiment, the plastic element includes openings in the raised rim. Each one of these openings results from the passage of a molding pocket that contributes to form one or several locking surfaces.

According to an embodiment, the plastic element includes a positioning feature on the bottom border segment. This positioning feature helps positioning and maintaining the metal insert on the plastic element.

According to an embodiment, the fastener assembly includes retention means cooperating with the rod and the insert to retain the plastic element on the metallic element. For example, the retention means includes at least one element from the list including a washer, a nut, a clip, a circlip. This list being not limitative.

According to another aspect, it is disclosed below a method for assembling a fastener assembly mentioned above. This method includes in particular the following operations: mounting the insert on the plastic element, mounting the plastic element on the metallic element in sliding the plastic element on the metallic element essentially parallel to the insertion direction (and essentially parallel to the plane of the fastening region), with the rod inserted in the inlet.

### BRIEF DESCRIPTION OF THE DRAWINGS

FIG. 1 is a schematic perspective view of an example of embodiment of a fastener assembly.

FIG. 2 is a schematic perspective view of the top face of a plastic element configured to be mounted with the fastener assembly shown in FIG. 1.

FIG. 3 is a schematic perspective view of the bottom face of a plastic element shown in FIG. 2.

FIG. 4 is a schematic perspective view of another example of plastic element configured to be mounted with the fastener assembly shown in FIG. 1.

FIG. 5 is a schematic perspective view of another example of plastic element configured to be mounted on a metal element.

### DETAILED DESCRIPTION

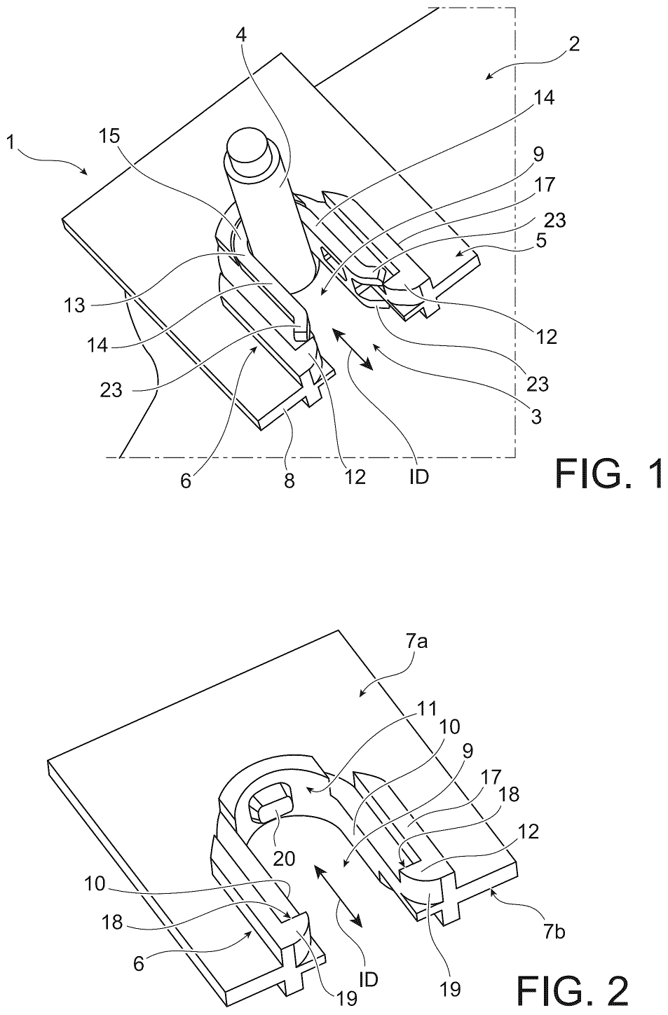

The disclosure illustrated in FIGS. 1 and 2 relates to a fastener assembly 1. This fastener assembly 1 includes at least one a metallic element 2, at least one rod 4, at least one plastic element 5, at least one metal insert 13 and, optionally, at least one retention means (not shown).

The fastener assembly 1 can be used particularly (but not exclusively) when it is possible to fasten a plastic element 5 on a metallic element 2 with a movement parallel to an insertion direction ID which is tangent to a surface of a fastening region 3 of the metallic element 2, the rod 4 being essentially perpendicularly to this surface of the fastening region 3. This corresponds to a radial installation direction. The illustrated fastener assembly 1, is easy, quick, and cost-effective to install.

The rod 4 is integral with, or secured to, the metallic element 2. For example, the rod 4 is welded to the metallic element 2. Optionally, the rod 4 is threaded so as to receive a nut. Alternatively, the rod 4 receives a washer.

The plastic element 5 is made by molding. The plastic element 5 is fixed to the metallic element 2 at the fastening region 3. The plastic element 5 includes a fixing portion 6 in the form of a plate having a top face 7a and a bottom face 7b. The bottom face 7b faces the metallic element 2. In FIGS. 1 to 4, only a part, which is essentially square in shape, of the plastic element 5 is shown. In alternative embodiments, the plastic element 5 can have any shape extending beyond the portion shown. The fixing portion 6 extends essentially in a plane and is provided with an edge 8 and an inlet 9 open at the edge 8. The inlet 9 is bordered by two longitudinal border segments 10 (see FIG. 2). For example, the two longitudinal border segments 10 are essentially parallel to each other and essentially parallel to the insertion direction ID. Both longitudinal border segments 10 extend essentially parallel to the plane of the plate-like shape of the fixing portion 6. The inlet 9 is also bordered by a bottom border segment 11. The bottom border segment 11 also extends essentially parallel to the plane of the plate-like shape of the fixing portion 6. The bottom border segment 11 extends between the two longitudinal border segments 10.

The plastic element 5 also includes locking means 12. For example, the locking means 12 are arranged in a raised rim 17. For example, the locking means 12 have a hook-shape. The raised rim 17 surrounds the inlet 9 along the longitudinal border segments 10 and the bottom border segment 11.

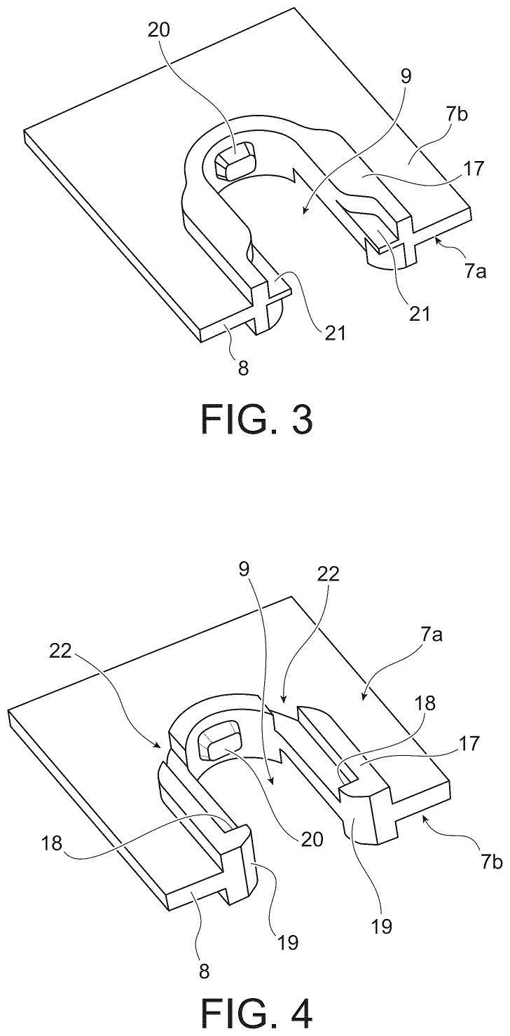

For example, at least two versions of the plate can be designed: an asymmetrical version (see FIGS. 2 and 3) and a symmetrical version (see FIG. 4). For example, in the asymmetrical embodiment of the plate, each locking means 12 of the top face 7a includes at least one locking surface 18 (in the illustrated example, there are two locking surfaces 18). In the symmetrical embodiment of the plate, each locking means 12 of both the top face 7a and the bottom face 7b, includes at least one locking surface 18 (in the illustrated example, there are four locking surfaces 18, i.e., two locking surfaces 18 on one and the other of the faces 7a, 7b). In each embodiment, the locking surfaces 18 are perpendicular to the insertion direction ID.

The fastener assembly also includes a metal insert 13 including two essentially parallel legs 14 and a junction 15 between the two legs 14. The metal insert 13 is essentially U-shaped. The insert 13 is symmetrical with regard to a plane parallel to the plate (as well as perpendicular to a plane perpendicular to the plate). The insert 13 is inserted into the inlet 9 with the rod 4 placed between the two legs 14. Advantageously, the insert 13 has a thickness (i.e., a dimension perpendicular to a plane parallel to the plate) which is equal or greater than the thickness of the fixing portion 6 (including the raised rims 17 on the top and bottom sides 7a, 7b). For example, the rod 4 abuts the curved portion, i.e., the junction 15, of the metal insert 13. Each one of the legs 14 includes, at its free end, two hooking means 23 configured to cooperate with the locking surfaces 18 of the locking means 12. Each hooking means 23 is formed by an extension of a leg 14 bent outwardly relatively to the inlet 9. When the metal insert 13 is mounted on the plastic element, the two hooking means 23 of one of the legs 14 each extend above or below the fixing portion 6, respectively. The raised rim 17 includes, in the vicinity of the edge 8, slanted surfaces 19 configured to case the insertion and the mounting, in the insertion direction ID, of the insert 13 in the inlet 9.

In the asymmetric embodiment (see FIG. 3), the raised rim 17 of the bottom face 7b includes, in the vicinity of the edge 8, a notch 21 for accommodating hooking means 23 on the bottom face 7b, whereas on the top face 7a, each hooking means 23 is accommodated behind a locking surface 18. In the symmetric embodiment (see FIG. 4), each hooking means 23 is accommodated behind a locking surface 18. Hence, both in the asymmetric embodiment and in the symmetric embodiment the insert 13 straddles the edge of the inlet 9.

Further, the bottom border segment 11 includes a positioning feature 20. The insert 13 includes a cavity configured to engage the positioning feature 20. Thereby, the insert 13 is stuck between the positioning feature 20 and the locking surfaces 18. This and/or the fact that the insert 13 straddles the edge of the inlet 9 avoids the insert 13 from being lost before mounting the plastic element 5 on the metallic element 2.

The plastic element 5 is particularly easy to be molded. There is no need of molding sliders. Advantageously, the raised rim 17 includes openings 22 in the raised rim 17 for forming the locking surfaces 18 with molding pockets extending in the insertion direction ID (see FIG. 4).

One can note that the direction of installation (i.e., essentially parallel to the insertion direction ID) of the plastic element 5 on the rod 4 coincides with the ‘molding direction’. The molding pocket shape (corresponding to the room left of the metal insert) has a general direction which aligned with the molding/de-molding direction of the whole plastic element. This makes it possible to mold the plastic element in the direction of installation, eliminating the need for sliders in the mold.

The method for assembling the fastener assembly, i.e., the method for installing the plastic element onto the metallic element, includes at least the following steps:
mounting the insert 13 on the plastic element 5 (i.e., inserting, in a direction essentially parallel to the plane of the plate of the fixing portion 6, the insert in the inlet 9 from the edge 8 up to a position in which the hooking means 23 are locked behind the locking surfaces 18);
mounting the plastic element 5 on the metallic element 2 in sliding the plastic element 5 on the metallic element 2, advantageously parallel to the insertion direction ID (i.e., perpendicular to the longitudinal direction of the rod, with the rod 4 engaging the inlet 9 from the edge 8 to the bottom border segment 11);
and securing the plastic element 5 onto the metallic element with fastening means such as a nut, a clip, a circlip, etc., engaging the rod 4; alternatively, the plastic element 5 is fixed onto the metallic element 3, with the metal insert 13 welded onto the rod 4.

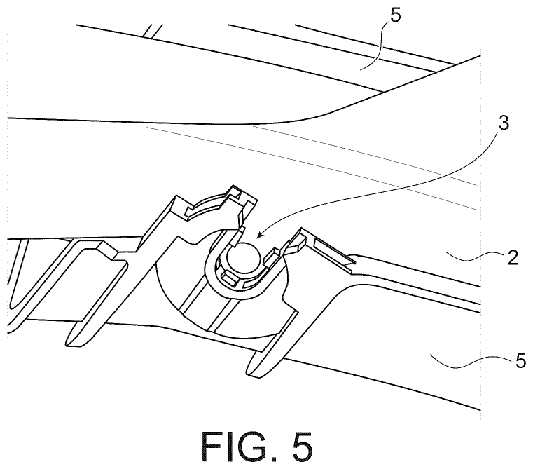

In an example embodiment illustrated in FIG. 5, the metallic element 2 is a vehicle frame and the plastic element 5 is a cable channel to be fastened on the vehicle frame (for the sake of clarity, the rod/stud 4 is just represented as a circle on the surface of the metallic element and the metal insert is not shown in FIG. 5). Such a cable channel is designed for example for accommodating power cables of an electric vehicle or hybrid electric vehicle. For these applications, new harness architectures require stable and durable cable channels in tight areas, as well as meeting stringent requirements in terms of vibrations, mounting, manufacturability and temperature. The disclosed solution minimizes the assembly space required while maintaining the required strength parameters.

However, other applications can be found to this fastener assembly 1. For example, this fastener assembly is applicable to any “plastic element or device to be attached on a surface provided with a stud” (e.g. a fuse block, an electrical control, a channel, an intelligent control unit, etc.).

While this invention has been described in terms of the preferred embodiments thereof, it is not intended to be so limited, but rather only to the extent assembly forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no feature limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

The term “and/or” is only an association relationship describing associated objects and represents that three relationships may exist. For example, A and/or B may represent three conditions: i.e., independent existence of A, existence of both A and B and independent existence of B. In addition, the character “/” in the disclosure usually represents that previous and next associated objects form an “or” relationship.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

The invention claimed is:

1. A fastener assembly, comprising:
a plastic element comprising a fixing portion in the form of a plate having a top face and a bottom face, extending essentially in a plane and provided with an edge and an inlet open at the edge, the inlet being bordered by two longitudinal border segments extending parallel to the plane of the plate in an insertion direction, and a bottom border segment also extending parallel to the plane of the plate between the two longitudinal border segments, the plastic element also comprising locking means; and
a metal insert comprising two legs and a junction between the two legs, the metal insert being essentially U-shaped, each one of the legs comprising hooking means cooperating with the locking means.

2. The fastener assembly of claim 1, comprising, on both the top face and the bottom face, a raised rim around the inlet, the locking means comprising at least one locking surface formed on at least one of the top face and the bottom face, in the raised rim, perpendicular to the insertion direction, the hooking means cooperating with the at least one locking surface.

3. The fastener assembly of claim 2, wherein, on the bottom face, the raised rim comprises at least one notch for accommodating hooking means near the edge.

4. The fastener assembly of claim 1, comprising on both the top face and the bottom face, a raised rim around the inlet, the locking means comprising at least one locking surface formed on both the top face and the bottom face, in the raised rim, perpendicular to the insertion direction, the hooking means cooperating with the locking surfaces on both the top face and the bottom face.

5. The fastener assembly of claim 4, wherein the raised rim comprises slanted surfaces near the edge, configured to ease the insertion, of the insert in the inlet in the insertion direction.

6. The fastener assembly of claim 2, wherein the plastic element comprises openings in the raised rim.

7. The fastener assembly of claim 1, comprising a positioning feature for the metal insert, on the bottom border segment.

8. The fastener assembly of claim 1, further comprising:
a metallic element comprising a fastening region; and
a rod secured to the metallic element and extending substantially perpendicularly to the fastening region, the plastic element being fixed to the metallic element at the fastening region, with the insert being placed into the inlet, with the rod placed between the two legs.

9. The fastener assembly of claim 8, further comprising retention means cooperating with the rod and the insert to retain the plastic element on the metallic element.

10. A method for assembling a fastener assembly, the fastener assembly comprising:
a metallic element comprising a fastening region;
a rod secured to the metallic element and extending substantially perpendicularly to the fastening region; and
a plastic element fixed to the metallic element at the fastening region, the plastic element comprising a fixing portion in the form of a plate having a top face and a bottom face, extending essentially in a plane and provided with an edge and an inlet open at the edge, the inlet being bordered by two longitudinal border segments extending parallel to the plane of the plate in an insertion direction, and a bottom border segment also extending parallel to the plane of the plate between the two longitudinal border segments, the plastic element also comprising locking means, the method comprising the steps of:
mounting a metal insert on the plastic element, the metal insert comprising two legs and a junction between the two legs, the metal insert being essentially U-shaped, the insert being inserted into the inlet with the rod placed between the two legs, each one of the legs comprising hooking means cooperating with the locking means; and
mounting the plastic element on the metallic element in sliding the plastic element on the metallic element parallel to the insertion direction.
